(19) United States
(12) Patent Application Publication
(10) Pub. No.: US 2025/0045967 A1
(43) Pub. Date: Feb. 6, 2025

(54) ELIMINATING NON-IMPORTANT MOTION IN IMAGE SEQUENCES

(71) Applicant: Varjo Technologies Oy, Helsinki (FI)

(72) Inventors: Mikko Strandborg, Helsinki (FI); Kai Inha, Helsinki (FI)

(73) Assignee: Varjo Technologies Oy, Helsinki (FI)

(21) Appl. No.: 18/361,982

(22) Filed: Jul. 31, 2023

(51) Int. Cl. G06T 9/00; G06T 7/246; G06T 7/70

(52) U.S. Cl. CPC G06T 9/00; G06T 7/248; G06T 7/70

(57) ABSTRACT

A gaze location is identified in a given image, based on a given gaze direction. The given image is divided into a plurality of areas. For a given area of the given image, a corresponding area is identified in at least one previous image. An extent of change is determined between the corresponding area of the at least one previous image and the given area of the given image. An importance factor is then calculated for the given area of the given image, based on the determined extent of change and a distance of the given area from the gaze location. The given image is encoded into encoded image data. When the importance factor for the given area is smaller than a first predefined threshold, the step of encoding comprises re-using previous encoded data of the corresponding area, instead of encoding replacing the given area in of the given image with the corresponding area into the encoded image data.

### TECHNICAL FIELD

The present disclosure relates to systems for encoding images. The present disclosure relates to methods for encoding images.

### BACKGROUND

Encoding is popularly used as a technique for compressing images in order to reduce a size, thereby enabling to transmit the images in a bandwidth-efficient manner, for example, across a communication network. Conventional encoders possess certain limitations. Mainly, conventional encoders identify regions of interest in the images, and employ extra bits to encode such regions, as compared to other regions in the images. However, there is a limit to a number of bits that can be employed. Moreover, utilising extra bits makes the encoding more complex, and thus, adds on to delays.

Therefore, in light of the foregoing discussion, there exists a need to overcome the aforementioned drawbacks.

### SUMMARY

The aim of the present disclosure is to provide a system and a method that are capable of encoding images in computationally-efficient and time-efficient manner. The aim of the present disclosure is achieved by a system and a method in which non-important motion is identified and eliminated, as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 illustrates a sequence diagram of a data flow in a system for encoding images, in accordance with an embodiment of the present disclosure; and

FIG. 2 illustrates steps of a method for encoding, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, an embodiment of the present disclosure provides a computer-implemented method comprising:
identifying a gaze location in a given image, based on a given gaze direction;
dividing the given image into a plurality of areas;
for a given area of the given image, identifying a corresponding area in at least one previous image;
determining an extent of change between the corresponding area of the at least one previous image and the given area of the given image;
calculating an importance factor for the given area of the given image, based on the determined extent of change and a distance of the given area from the gaze location; and
encoding the given image into encoded image data, wherein when the importance factor for the given area is smaller than a first predefined threshold, the step of encoding comprises re-using previous encoded data of the corresponding area, instead of encoding the given area of the given image into the encoded image data.

In a second aspect, an embodiment of the present disclosure provides a system comprising at least one server configured to:
identify a gaze location in a given image, based on a given gaze direction;
divide the given image into a plurality of areas;
for a given area of the given image, identify a corresponding area in at least one previous image;
determine an extent of change between the corresponding area of the at least one previous image and the given area of the given image;
calculate an importance factor for the given area of the given image, based on the determined extent of change and a distance of the given area from the gaze location; and
encode the given image into encoded image data, wherein when encoding, the at least one server is configured to re-use previous encoded data of the corresponding area, instead of encoding the given area of the given image into the encoded image data, when the importance factor for the given area is smaller than a first predefined threshold.

In a third aspect, an embodiment of the present disclosure provides a computer program product comprising a non-transitory machine-readable data storage medium having stored thereon program instructions that, when executed by a processor, cause the processor to execute steps of the method of the aforementioned first aspect.

Pursuant to the present disclosure, a technical benefit of employing the importance factor (that is calculated based on the extent of change and the distance of the given area from the gaze location) is that it allows to accurately distinguish between area(s) of the given image in which non-important (secondary) motion has occurred and other area(s) of the given image in which non-important motion has not occurred (that is, the other areas in which important motion may have occurred). In this regard, when the importance factor for the given area is smaller than the first predefined threshold, the given area is considered to have a non-important motion. Hereinafter, area(s) whose importance factor is smaller than the first predefined threshold will be referred to as “non-important areas”, whereas other area(s) whose importance factor is not smaller than the first predefined threshold will be referred to as “important areas”, for the sake of convenience only. Throughout the present disclosure, the term “important motion” refers to a motion in a visual scene (presented to a user via a sequence of images including a given decoded image corresponding to the given image) that is important to the user, for example, from the point of view of her/his region of interest in the visual scene. In other words, any motion that is perceivable to the user and/or any motion on which the user's gaze is focused may be considered as an “important motion”.

When calculating the importance factor, taking the distance of the given area from the gaze location into account allows to emulate a manner in which a human visual system perceives a visual scene, wherein gaze-contingent area(s) are more detailed in visual information as compared to peripheral areas of the visual scene. Moreover, the extent of change is taken into account when calculating the importance factor, because a drastic change in any area of a visual scene is likely to be more noticeable to the user as compared to a subtle change in any other area; this applies well to even the peripheral areas of the visual scene, because the human visual system is capable of noticing flicker and noise in the peripheral areas. Thus, the extent of change and the distance of the given area from the gaze location play a synergistic role in calculating the importance factor for distinguishing between the important areas and the non-important areas of the given image.

Pursuant to the present disclosure, the non-important area(s) of the given image are not processed and encoded into the encoded image data.

In such a case, previous encoded data of the corresponding area(s) of the at least one previous image is re-used, instead of encoding the non-important area(s) of the given image into the encoded image data. This allows to reduce any wastage of processing resources in encoding the non-important area(s). This, in turn, allows to use the processing resources more appropriately for the important area(s) of the given image. It will be appreciated that video streaming is at a core of extended-reality (XR) applications these days; in a wireless setup, the aforementioned method and system allow to reduce unnecessary processing and thus power consumption. From the point of view of the user, it is important to represent an important motion clearly in the given image. A technical benefit of utilising an available amount of processing resources in processing and encoding the important area(s) of the given image, instead of wasting these processing resources in processing and encoding the non-important area(s) of the given image, is that the user's viewing experience is highly improved. This is because when the encoded image data is subsequently decoded at a client device of the user to generate the given decoded image, the given decoded image has a high image quality and latest visual update in the important area(s) (which are of interest to the user), whilst having a comparatively low image quality in the non-important area(s) (which are of no interest or comparatively low interest to the user). Notably, due to this, encoding is performed in a computationally-efficient and time-efficient manner.

Moreover, at the client device, decoding is also performed in a computationally-efficient and time-efficient manner, thereby reducing computational burden, delays, and excessive power consumption.

In some implementations, the given image could be processed to replace the non-important area(s) of the given image with corresponding area(s) of the at least one previous image. Such a processing is beneficially performed prior to encoding the given image. This enables to compress the sequence of images including the at least one previous image and the given image (which constitute a video stream) in a more efficient manner, because no bits are wasted in encoding the non-important area(s) of the given image. This makes the video stream more compressible by eliminating non-important motion from the given image. It will be appreciated that in alternative implementations, the given image need not be processed to replace the non-important area(s) of the given image with the corresponding area(s) of the at least one previous image; in such alternative implementations, the previous encoded data of the corresponding area(s) could be re-used directly at the time of encoding.

Additionally, the given image could be optionally foveated, after replacing the non-important area(s) with the corresponding area(s), and prior to the encoding. This prevents sizzling artifacts in highly downscaled areas of the given decoded image, which are caused by aliasing. It is well known that when a highly-downscaled area has motion, moving features in said area can easily be smaller than a footprint of a single pixel, causing aliasing or “sizzling” artifacts. Throughout the present disclosure, the term “foveation process” refers to a process that downscales peripheral area(s) of a given image. As a result, a packed framebuffer of the given image has a spatially non-uniform resolution. In such a case, a gaze-contingent area or a central area of the given image (depending on whether active foveation or fixed foveation is implemented) could be left at an original resolution, whilst downscaling the peripheral area(s) to a lower resolution as compared to the original resolution. As a result, the gaze-contingent area or the central area has a higher pixels per degree (PPD) as compared to the peripheral area(s). This is particularly beneficial for images in which it is most important to focus and concentrate on motion represented in the gaze-contingent area or the central area.

There will now be provided details of the steps of the aforementioned method. Throughout the present disclosure, the term “given area” refers to any area from amongst the plurality of areas of the given image. The steps have been recited with respect to the given area, for the sake of clarity only. These steps can be performed in a similar manner for all the areas of the given image.

### Identification of Gaze Location

Throughout the present disclosure, the term “gaze location” refers to a point or a region in the given image that corresponds to the given gaze direction. As an example, the gaze location could be a single point, namely a single pixel of the given image. As another example, the gaze location could be a region having an angular width of 2-5 degrees with respect to a user's eye. As yet another example, the gaze location could be a region having an array of pixels.

Optionally, the step of identifying the gaze location in the given image comprises mapping the given gaze direction onto a field of view of the given image. In fixed-foveation implementations, the given gaze direction could be considered to be directed along a default gaze direction that is directed towards a centre of the field of view, namely directed straight towards a centre of the given image. In active-foveation implementations, the given gaze direction could be a gaze direction of the user's eye, or an average of gaze directions of multiple users in multi-user scenarios. The at least one server could be communicably coupled to at least one client device. Information indicative of the gaze direction of the user's eye could be obtained from the at least one client device. Such a client device could be implemented, for example, as a head-mounted display (HMD) device or a computing device that is communicably coupled to the HMD device. The gaze direction may be tracked at the at least one client device by employing a gaze-tracking means. The gaze-tracking means could be implemented as contact lenses with sensors, cameras monitoring a position, a size and/or a shape of a pupil of the user's eye, and the like. Such gaze-tracking means are well-known in the art. The term “head-mounted display” device refers to a specialized equipment that is configured to present an extended-reality (XR) environment to a user when said HMD device, in operation, is worn by the user on his/her head. The HMD device can be implemented, for example, as an XR headset, a pair of XR glasses, and the like, that is operable to display a visual scene of the XR environment to the user. The term “extended-reality” encompasses virtual reality (VR), augmented reality (AR), mixed reality (MR), and the like.

Moreover, the gaze direction could be a current gaze direction or a predicted gaze direction of the user. It will be appreciated that the predicted gaze direction could be determined, based on a change in the user's gaze over a period of time. In such a case, the change in the user's gaze could be determined in terms of a gaze velocity and/or a gaze acceleration, using information indicative of previous gaze directions and the current gaze direction of the user's eye.

Division of Image into Areas

In some implementations, the image could be divided into fixed-sized areas. At a basic level, this can be even performed on a per-pixel basis.

In other implementations, the image could be divided into different-sized areas, for example, based on at least one of: velocity vector analysis, depth analysis, alpha analysis, contrast analysis, image features.

As an example, such different-sized areas may be identified as groups of neighbouring pixels in the given image, wherein pixels of a given area have at least one of: velocity vectors that lie within a predefined threshold angle from each other, velocity vectors whose magnitude lie within a predefined threshold value from each other. Optionally, the predefined threshold angle lies in a range of 0 to 45 degrees; more optionally, in a range of 0 degree to 30 degrees; yet more optionally, in a range of 0 degree to 20 degrees. Optionally, the predefined threshold value lies in a range of 0 to 10 pixels per milliseconds; more optionally, in a range of 0 to 2 pixels per milliseconds. It will be appreciated that the predefined threshold value depends on the resolution of the given image. Notably, if the resolution doubles, the predefined threshold value would also need to double, to accommodate the change in the resolution. It will be appreciated here that velocity vectors can be known from a velocity channel corresponding to the given image. Dividing the given image based on the groups of neighbouring pixels whose velocity vectors are similar allows for a fast and efficient identification of the important areas and the non-important areas as well as encoding of the given image.

As another example, the different-sized areas may be identified as groups of neighbouring pixels in the given image, whose depth values lie within a predefined threshold value from each other. Optionally, the predefined threshold value lies in a range of 0 to 30 cm; more optionally, in a range of 0 to 20 cm.

As yet another example, the different-sized areas may additionally or alternatively be identified based on a similar kind of analysis of alpha values and/or contrast. Such analysis is well-known in the prior art.

As still another example, image features could be extracted from the given image, and object boundaries could be determined to identify different areas of the given image.

### Identification of Corresponding Area in Previous Image

In a case where the given area represents a dynamic object or a part thereof, pixel coordinates of the given area in the given image may be different from pixel coordinates of the corresponding area in the at least one previous image, because it is possible that the dynamic object or its part moved or changed shape across a sequence of images and/or the images in said sequence are captured from different poses. Therefore, a location of the given area in the given image may be different from a location of the corresponding area in the at least one previous image.

In some implementations, the corresponding area can be identified using reprojection. Optionally, in this regard, the method further comprises reprojecting the at least one previous image from a corresponding previous pose to a given pose, prior to identifying the corresponding area in the at least one previous image, the at least one previous image and the given image being rendered according to the corresponding previous pose and the given pose, respectively. In this regard, the images may have been rendered by the at least one server, for example, using a three-dimensional (3D) model of an XR environment. For this purpose, the at least one server is optionally configured to obtain the 3D model from at least one data repository. The term “3D model” of the XR environment refers to a data structure that comprises comprehensive information pertaining to objects or their parts present in the XR environment. Such comprehensive information is indicative of at least one of: surfaces of the objects or their parts, a plurality of features of the objects or their parts, shapes and sizes of the objects or their parts, poses of the objects or their parts, materials of the objects or their parts, colour information of the objects or their parts, depth information of the objects or their parts, light sources and lighting conditions within the extended-reality environment.

Optionally, the system further comprises the at least one data repository. The server could be configured to store the given image at the at least one data repository, to be used as a previous image for a next image.

Additionally, the server could be configured to obtain the at least one previous image from the at least one data repository. The at least one data repository could be implemented, for example, such as a memory of the at least one server, a memory of the computing device, a memory of the at least one client device, a removable memory, a cloud-based database, or similar. It will be appreciated that the at least one server can be implemented as a cloud server, or the computing device that is communicable coupled to the HMD.

Hereinabove, the term “previous pose” refers to a head pose or a device pose according to which the at least one previous image was rendered, whereas the term “given pose” refers to a head pose or a device pose according to which the given image was rendered. The term “pose” encompasses both position and orientation. It will be appreciated that in XR applications, pose information indicative of a pose could be obtained from the at least one client device. The pose may be tracked at the at least one client device by employing a pose-tracking means. The pose-tracking means could be implemented as at least one of: an optics-based tracking system (which utilizes, for example, infrared beacons and detectors, IR cameras, visible-light cameras, detectable objects and detectors, and the like), an acoustics-based tracking system, a radio-based tracking system, a magnetism-based tracking system, an accelerometer, a gyroscope, an Inertial Measurement Unit (IMU), a Timing and Inertial Measurement Unit (TIMU). Such pose-tracking means are well known in the art.

The reprojection can be performed using at least one space warping algorithm, which may perform any of: a three degrees-of-freedom (3DOF) reprojection, a six degrees-of-freedom (6DOF) reprojection, a nine degrees-of-freedom (9DOF) reprojection. Image reprojection algorithms are well-known in the art. Moreover, upon reprojecting the at least one previous image, missing values in the at least one reprojected previous image may be generated using suitable image processing techniques (for example, such as inpainting technique, interpolation technique, extrapolation technique, or similar). It will be appreciated that the values may be considered to be matching, when there is an exact match or a near-exact match (for example, +/−5 percent difference from each other).

Employing the reprojection allows to identify the corresponding area with ease, as both the given area and a reprojection of the corresponding area can be compared from a perspective of the same pose, namely the given pose. In such a case, all the steps of the method can then be performed using the at least one reprojected previous image.

Additionally or alternatively, the corresponding area can be identified based on matching of pixel values (for example, colour values, depth values, alpha values, or similar) in the given area of the given image with pixel values in the corresponding area of the at least one previous image.

### Determination of Extent of Change

The extent of change between the corresponding area of the at least one previous image and the given area of the given image can be determined in terms of percentage. As an example, the values of the pixels of the given area can be compared with values of corresponding pixels of the at least one previous image at a per-pixel basis, to determine a change in the values. In such a case, the extent of change for an entirety of the given area can be calculated as a sum of individual percentages of change in the values. It will be appreciated that such percentages can be calculated with respect to the values of the pixels of the given area in some implementations, and with respect to the values of the corresponding pixels of the at least one previous image in other implementations.

As another example, when a dynamic object may have changed its shape, a relative position of the pixels of the given area with respect to other pixels at a boundary of the given area can be compared with a relative position of the corresponding pixels of the at least one previous image with respect to other pixels at a boundary of the corresponding area at a per-pixel basis. In such a case, the extent of change for the entirety of the given area can be calculated as a sum of individual percentages of change in the relative positions. It will be appreciated that such percentages can be calculated with respect to the relative position of the pixels of the given area in some implementations, and with respect to the relative position of the corresponding pixels of the at least one previous image in other implementations.

### Calculation of Importance Factor

The importance factor can be calculated by utilising a mathematical function of the determined extent of change and the distance of the given area from the gaze location. In such a case, the distance could be measured in terms of an angular distance or in pixels. The distance could beneficially be measured from the gaze location to an approximate centre of the given area. The mathematical function could be pre-defined in a manner that when the distance increases, the importance factor decreases, and when the extent of change increases, the importance factor also increases.

As an example, the mathematical function could be implemented as a multiplication product of the extent of change (that may be determined in terms of percentage) and a reciprocal of the distance between the given area and the gaze location. As another example, the mathematical function could be implemented as a mathematical product of the extent of change and a reciprocal of a square of the distance. A person skilled in the art will recognize many variations, alternatives, and modifications of such a mathematical function. As an example, the mathematical function could also take a constant value into account. For example, the mathematical function could, for example, be implemented as a multiplication product of the constant value, the extent of change, and the reciprocal of the distance.

It will be appreciated that the first predefined threshold can be selected depending on a minimum value and a maximum value of the importance factor. The minimum value and the maximum value depend on the unit of the distance (for example, angles, pixels or similar). The minimum value can be calculated from an analysis of change in peripheral areas of a sequence of images, where the change is almost zero. On the other hand, the maximum value can be calculated from an analysis of change in other areas of the sequence of images that are in a proximity of the gaze location, where the change is drastic. In this regard, the change can be considered to be drastic, for example, when more than 50 percent of the pixels have either different values or different relative positions with respect to boundary pixels.

Moreover, the importance factor can be normalised. As an example, the importance factor can be normalised from an original range of the minimum value—the maximum value to a range of 0-1 or similar.

The at least one previous image could comprise a plurality of previous images. Optionally, in such a case, the method further comprises tracking changes in the given area across a sequence of images, said sequence comprising the plurality of previous images and the given image.

Optionally, in this regard, the importance factor is calculated for the given area of the given image, further based on at least one of: an extent of the tracked changes across the sequence of images, a rate with which the changes have occurred across the sequence of images. A technical benefit of tracking the changes across the sequence of images is that it allows to predict an upcoming change in the given image (with respect to the at least one previous image), and therefore, allows to perform the steps of identifying the corresponding area, determining the extent of change, and calculating the importance factor more accurately and time efficiently. This, in turn, allows for distinguishing between the important areas and the non-important areas in a more accurate and efficient manner.

### Encoding of Given Image

Optionally, for each area of the given image whose importance factor is smaller than the first predefined threshold, the encoded image data comprises a reference to previous encoded data of a corresponding area of the at least one previous image that is to be re-used for said area of the given image. The reference to the previous encoded data could be in a form of at least one of: a pointer pointing to the previous encoded data in a stream of the encoded image data, a unique identification of the previous encoded data. Including the reference to the previous encoded data of the corresponding area in the encoded image data allows a decoder to access the previous encoded data of the corresponding area, thereby enabling the decoder to first decode the previous encoded data into a corresponding decoded area and re-use the corresponding decoded area for generating the given decoded image corresponding to the given image.

Moreover, optionally, the method further comprises attaching, with the given image, metainformation indicative of at least one of:
areas of the given image for which previous encoded data of their corresponding areas of the at least one previous image are to be re-used,
positions of the corresponding areas of the at least one previous image,
relative positions of the corresponding areas of the at least one previous image with respect to the areas of the given image,
respective rotation to be applied to the corresponding areas,
respective scaling to be applied to the corresponding areas.

The metainformation enables the decoder to decode the encoded image data correctly, as it provides information about the non-important areas of the given image, and how to re-use the previous encoded data of the corresponding areas for re-creating the non-important areas at the time of decoding.

Notably, when a particular non-important area is indicated in the metainformation, it allows for accurately positioning a re-created area (corresponding to that particular non-important area) in the given decoded image, at the time of decoding. Such an area may be indicated using position coordinates of its corners or points on its boundary.

When the metainformation indicates a position of a corresponding area in the at least one previous image (corresponding to the particular non-important area), it allows to find a corresponding re-created area in a previous decoded image, which may then be re-used as the recreated area in the given decoded image. Additionally, it allows to accurately re-project the corresponding re-created area of the previous decoded image, thereby enabling accurate positioning and orientating of the re-created area in the given decoded image. Alternatively, the metainformation could indicate the relative position of the corresponding areas, instead of the positions. In other words, the positions need not be absolute positions, and can be defined in relative terms also.

When the metainformation indicates the rotation to be applied, it allows to compensate for an angular difference between the perspective of the previous pose and the perspective of the given pose as well as to take into account any rotation undergone by an object or its part that is represented by the given area across the at least one previous image and the given image. In such a case, this rotation can be applied to the corresponding re-created area of the previous decoded image to obtain the re-created area of the given decoded image (corresponding to the given area), at the time of decoding.

When the metainformation indicates the scaling to be applied, it allows to compensate for a difference in a size of the given area and the corresponding area, for example, due to a difference between the given pose and the previous pose, and/or a movement of the object towards or away from the user. The term “scaling” encompasses downscaling and/or upscaling. The scaling can be applied to the corresponding re-created area of the previous decoded image to obtain the re-created area of the given decoded image (corresponding to the given area), at the time of decoding.

Furthermore, the important areas can be further sub-divided into areas having different levels of importance. In this regard, when the importance factor for the given area is greater than a second predefined threshold, the given area can be considered as a “very important area”. On the other hand, when the importance factor for the given area is greater than or equal to the first predefined threshold, but smaller than the second predefined threshold, the given area can be considered as a “less important area”. It will be appreciated that the first predefined threshold and the second predefined threshold can be selected depending on the minimum value and the maximum value of the importance factor. As an example, when the minimum value and the maximum value are normalised to 0 and 1, the first predefined threshold can be selected from a range of 0.25 to 0.40, whereas the second predefined threshold can be selected from a range of 0.55 to 0.75. Moreover, the selection can be performed based on a use case scenario.

Optionally, the method further comprises encoding original values of the pixels of the given area into the encoded image data, when the importance factor for the given area is greater than the second predefined threshold. Optionally, in this regard, the step of encoding the given image comprises encoding the given area of the given image as anew into the encoded image data, when the importance factor for the given area is greater than the second predefined threshold. In such a case, the given area is encoded from the scratch. The encoded data of the given area (encoded as anew) could then beneficially be usable later for encoding corresponding area(s) of subsequent images. The encoding could be performed using well-known encoding techniques, for example, such as H.264, H.265, H.266, AOMedia Video 1 (AV1), VP9, and the like.

Optionally, the method further comprises when the importance factor for the given area is greater than or equal to the first predefined threshold, but smaller than a second predefined threshold, interpolating between original values of pixels of the given area of the given image and values of corresponding pixels of the corresponding area of the at least one previous image, based on the importance factor calculated for the given area, to generate interpolated values for the pixels of the given area, and encoding the interpolated values into the encoded image data. In some implementations, the interpolation could be performed linearly based on the importance score. In such a case, the interpolation could be performed based on whether the importance score of the given area is relatively closer to the first predefined threshold or to the second predefined threshold, and optionally, based on how close the importance score is to the first predefined threshold.

The present disclosure also relates to the system as described above. Various embodiments and variants disclosed above, with respect to the aforementioned method, apply mutatis mutandis to the system and the computer program product.

Optionally, the at least one server is configured to reproject the at least one previous image from a corresponding previous pose to a given pose, prior to identifying the corresponding area in the at least one previous image, as described earlier. The at least one previous image and the given image are rendered according to the corresponding previous pose and the given pose, respectively.

In some implementations, the at least one previous image comprises a plurality of previous images. Optionally, in such implementations, the at least one server is configured to track changes in the given area across a sequence of images, said sequence comprising the plurality of previous images and the given image, wherein the importance factor is calculated for the given area of the given image, further based on at least one of: an extent of the tracked changes across the sequence of images, a rate with which the changes have occurred across the sequence of images.

Optionally, for each area of the given image whose importance factor is smaller than the first predefined threshold, the encoded image data comprises a reference to previous encoded data of a corresponding area of the at least one previous image that is to be re-used for said area of the given image. Moreover, optionally, the at least one server is configured to attach, with the given image, metainformation indicative of at least one of:
areas of the given image for which previous encoded data of their corresponding areas of the at least one previous image are to be re-used,
positions of the corresponding areas of the at least one previous image,
relative positions of the corresponding areas of the at least one previous image with respect to the areas of the given image,
respective rotation to be applied to the corresponding areas,
respective scaling to be applied to the corresponding areas.

Optionally, the at least one server is configured to when the importance factor for the given area is greater than the second predefined threshold, encode the original values of the pixels of the given area into the encoded image data, as described earlier.

Optionally, the at least one server is configured to when the importance factor for the given area is greater than or equal to the first predefined threshold, but smaller than a second predefined threshold, interpolate between original values of pixels of the given area of the given image and values of corresponding pixels of the corresponding area of the at least one previous image, based on the importance factor calculated for the given area, to generate interpolated values for the pixels of the given area, and encode the interpolated values into the encoded image data, as described earlier.

### DETAILED DESCRIPTION OF THE DRAWINGS

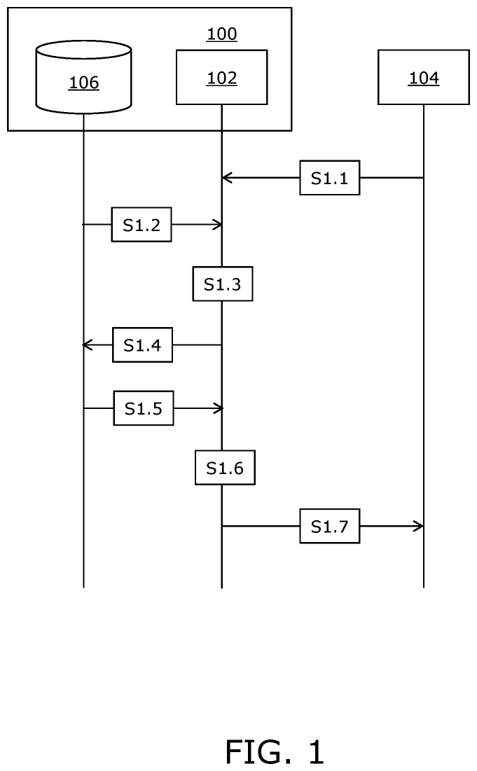

FIG. 1 illustrates a sequence diagram showing a data flow in a system 100 for encoding images, in accordance with an embodiment of the present disclosure. The system 100 comprises at least one server (depicted as a server 102) that is communicably coupled to at least one client device (depicted as a client device 104). The system 100 optionally comprises at least one data repository (depicted as a data repository 106) that is communicably coupled to the server 102.

At step S1.1, the server 102 obtains, from the client device 104, pose information indicative of a pose and optionally, information indicative of a gaze direction of a user. At step S1.2, the server 102 obtains a 3D model of an extended-reality environment from the data repository 106.

At step S1.3, the server 102 renders a given image according to the pose. At step S1.4, the server stores the given image at the data repository 106 to be used for a next image. At step S1.5, the server obtains at least one previous image from the data repository 106.

At step S1.6, the server performs the following operations:
identifies a gaze location in the given image, based on a given gaze direction (which could be the gaze direction of the user, an average gaze direction of multiple users, or a default gaze direction);
divides the given image into a plurality of areas;
for a given area of the given image, identifies a corresponding area in the at least one previous image;
determines an extent of change between the corresponding area of the at least one previous image and the given area of the given image; and
calculates an importance factor for the given area of the given image, based on the determined extent of change and a distance of the given area from the gaze location; and
encodes the given image into encoded image data, wherein when the importance factor for the given area is smaller than a first predefined threshold, previous encoded data of the corresponding area is re-used, instead of encoding the given area of the given image into the encoded image data.

At step S1.7, the server 102 sends the encoded image data to the client device 104, whereat the encoded image data is decoded to generate a decoded image.

It may be understood by a person skilled in the art that FIG. 1 illustrates a simplified sequence diagram of the system 100, for sake of clarity, which should not unduly limit the scope of the claims herein. It is to be understood that the specific implementation of the system 100 is provided as an example and is not to be construed as limiting it to specific numbers or types of servers, client devices, and data repositories. The person skilled in the art will recognize many variations, alternatives, and modifications of embodiments of the present disclosure.

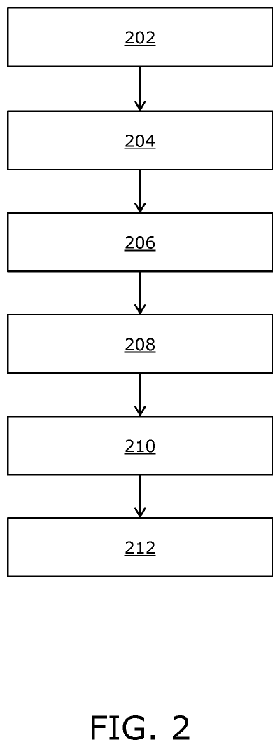

FIG. 2 illustrates steps of a method for encoding, in accordance with an embodiment of the present disclosure. At step 202, a gaze location is identified in a given image, based on a given gaze direction. At step 204, the given image is divided into a plurality of areas. At step 206, for a given area of the given image, a corresponding area is identified in at least one previous image. At step 208, an extent of change is determined between the corresponding area of the at least one previous image and the given area of the given image. At step 210, an importance factor is then calculated for the given area of the given image, based on the determined extent of change and a distance of the given area from the gaze location. Steps 206, 208 and 210 are performed for other areas of the given image as well. At step 212, the given image is encoded into encoded image data. When the importance factor for the given area is smaller than a first predefined threshold, the step of encoding comprises re-using previous encoded data of the corresponding area, instead of encoding replacing the given area in of the given image with the corresponding area into the encoded image data.

The aforementioned steps are only illustrative and other alternatives can also be provided where one or more steps are added, one or more steps are removed, or one or more steps are provided in a different sequence without departing from the scope of the claims.

1. A computer-implemented method comprising:
identifying a gaze location in a given image, based on a given gaze direction;
dividing the given image into a plurality of areas;
for a given area of the given image, identifying a corresponding area in at least one previous image;
determining an extent of change between the corresponding area of the at least one previous image and the given area of the given image;
calculating an importance factor for the given area of the given image, based on the determined extent of change and a distance of the given area from the gaze location; and
encoding the given image into encoded image data, wherein when the importance factor for the given area is smaller than a first predefined threshold, the step of encoding comprises re-using previous encoded data of the corresponding area, instead of encoding the given area of the given image into the encoded image data.

2. The computer-implemented method of claim 1, further comprising reprojecting the at least one previous image from a corresponding previous pose to a given pose, prior to identifying the corresponding area in the at least one previous image, the at least one previous image and the given image being rendered according to the corresponding previous pose and the given pose, respectively.

3. The computer-implemented method of claim 1, wherein the at least one previous image comprises a plurality of previous images, the method further comprising tracking changes in the given area across a sequence of images, said sequence comprising the plurality of previous images and the given image,
wherein the importance factor is calculated for the given area of the given image, further based on at least one of: an extent of the tracked changes across the sequence of images, a rate with which the changes have occurred across the sequence of images.

4. The computer-implemented method of claim 1, further comprising when the importance factor for the given area is greater than or equal to the first predefined threshold, but smaller than a second predefined threshold, interpolating between original values of pixels of the given area of the given image and values of corresponding pixels of the corresponding area of the at least one previous image, based on the importance factor calculated for the given area, to generate interpolated values for the pixels of the given area, and encoding the interpolated values into the encoded image data.

5. The computer-implemented method of claim 1, further comprising when the importance factor for the given area is greater than the second predefined threshold, encoding the original values of the pixels of the given area into the encoded image data.

6. The computer-implemented method of claim 1, further comprising attaching, with the given image, metainformation indicative of at least one of:
areas of the given image for which previous encoded data of their corresponding areas of the at least one previous image are to be re-used,
positions of the corresponding areas of the at least one previous image,
relative positions of the corresponding areas of the at least one previous image with respect to the areas of the given image,
respective rotation to be applied to the corresponding areas,
respective scaling to be applied to the corresponding areas.

7. The computer-implemented method of claim 1, wherein for each area of the given image whose importance factor is smaller than the first predefined threshold, the encoded image data comprises a reference to previous encoded data of a corresponding area of the at least one previous image that is to be re-used for said area of the given image.

8. A system comprising at least one server configured to:
identify a gaze location in a given image, based on a given gaze direction;
divide the given image into a plurality of areas;
for a given area of the given image, identify a corresponding area in at least one previous image;
determine an extent of change between the corresponding area of the at least one previous image and the given area of the given image;
calculate an importance factor for the given area of the given image, based on the determined extent of change and a distance of the given area from the gaze location; and
encode the given image into encoded image data, wherein when encoding, the at least one server is configured to re-use previous encoded data of the corresponding area, instead of encoding the given area of the given image into the encoded image data, when the importance factor for the given area is smaller than a first predefined threshold.

9. The system of claim 8, wherein the at least one server is configured to reproject the at least one previous image from a corresponding previous pose to a given pose, prior to identifying the corresponding area in the at least one previous image, the at least one previous image and the given image being rendered according to the corresponding previous pose and the given pose, respectively.

10. The system of claim 8, wherein the at least one previous image comprises a plurality of previous images, and wherein the at least one server is configured to track changes in the given area across a sequence of images, said sequence comprising the plurality of previous images and the given image,
wherein the importance factor is calculated for the given area of the given image, further based on at least one of: an extent of the tracked changes across the sequence of images, a rate with which the changes have occurred across the sequence of images.

11. The system of claim 8, wherein the at least one server is configured to when the importance factor for the given area is greater than or equal to the first predefined threshold, but smaller than a second predefined threshold, interpolate between original values of pixels of the given area of the given image and values of corresponding pixels of the corresponding area of the at least one previous image, based on the importance factor calculated for the given area, to generate interpolated values for the pixels of the given area, and encode the interpolated values into the encoded image data.

12. The system of claim 8, wherein the at least one server is configured to when the importance factor for the given area is greater than the second predefined threshold, encode the original values of the pixels of the given area into the encoded image data.

13. The system of claim 8, wherein the at least one server is configured to attach, with the given image, metainformation indicative of at least one of:
areas of the given image for which previous encoded data of their corresponding areas of the at least one previous image are to be re-used,
positions of the corresponding areas of the at least one previous image,
relative positions of the corresponding areas of the at least one previous image with respect to the areas of the given image,
respective rotation to be applied to the corresponding areas,
respective scaling to be applied to the corresponding areas.

14. The system of claim 8, wherein for each area of the given image whose importance factor is smaller than the first predefined threshold, the encoded image data comprises a reference to previous encoded data of a corresponding area of the at least one previous image that is to be re-used for said area of the given image.

15. A computer program product comprising a non-transitory machine-readable data storage medium having stored thereon program instructions that, when executed by a processor, cause the processor to execute steps of a method of claim 1.
